(19) United States
(12) Patent Application Publication
(10) Pub. No.: US 2023/0309469 A1
(43) Pub. Date: Oct. 5, 2023

(54) Plant growth medium and manufacturing method thereof

(71) Applicant: Ying Che Hsiao, Kaohsiung City (TW)

(72) Inventors: Chun Yu Hsiao, Kaohsiung City (TW); Ya Fang Hsiao, Kaohsiung City (TW); Ying Che Hsiao, Kaohsiung City (TW)

(21) Appl. No.: 18/193,452

(22) Filed: Mar. 30, 2023

(30) Foreign Application Priority Data
Apr. 1, 2022 (TW) 111112841
Apr. 8, 2022 (TW) 111203539

(51) Int. Cl. A01G 24/46

(52) U.S. Cl. CPC A01G 24/46

(57) ABSTRACT

A plant growth medium is provided, applicable to grow a plant. The plant growth medium includes a pre-medium cultivated with the plant and a post-medium. The post-medium includes a bottom wall, a surrounding wall extending upward from an outer edge of the bottom wall, and an accommodating space defined jointly by the bottom wall and the surrounding wall, where the pre-medium is accommodated in the accommodating space, and the post-medium is used to provide a growth environment for the plant.

### TECHNICAL FIELD

The disclosure relates to a plant growth medium, in particular to, a plant growth medium for expanding a plant root growth space and a manufacturing method thereof.

### BACKGROUND

The orchid family can be classified into ground, epiphytic, and saprophytic species. The roots of epiphytic orchids are aerial roots which can climb onto objects, being exposed to air, absorb moisture from the air, and even suck nutrients from the hosts. If aerial roots are in an environment with poor ventilation, they are prone to rotting. Therefore, the growth media generally used for orchids are structured with holes or slits for ventilation.

However, the growth media currently used for orchids still have the following disadvantages when used.

First, the structure is loose and not easy to process in large quantities:

The early growth medium is mainly processed manually with loose wood fibers. The user has to place the wood fibers in a container and then pressurize them for shaping. However, the manual processing method is not only complicated, but also requires a lot of physical effort, which is not conducive to mass production.

Second, the growth medium cannot be stably expanded:

As orchids grow in the pre-medium for a period of time, the growth medium is expanded. However, because the pre-medium is not fixed and the roots of orchids have to grow for a period to climb, the pre-medium when placed in the expanded growth medium or pot is likely to loosen and fall off in the early stage of expanding growth medium.

Third, the root growth space is insufficient:

When the root growth space is expanded for the orchid plant, the pre-medium closely fits the other media or pot, resulting in no space for the orchid plant roots to grow in the medium.

Therefore, how to save labor costs and implement mass production and how to firmly fix the pre-medium so as to prevent falling off in the early stage of expanding growth medium and also can provide enough growth space for orchid roots are the urgent problems for persons skilled in the art to solve.

### SUMMARY

In one embodiment, a plant growth medium, applicable to grow a plant comprises a pre-medium and a post-medium. The pre-medium is cultivated with the plant, and the post-medium includes a bottom wall, a surrounding wall extending upward from an outer edge of the bottom wall, and an accommodating space defined jointly by the bottom wall and the surrounding wall. The pre-medium is accommodated in the accommodating space to provide a growth environment for the plant.

In one embodiment, a manufacturing method, applicable to manufacture the plant growth medium, comprises a first preparation step of preparing a pre-medium cultivated with a plant, wherein the pre-medium is of a porous structure formed by a plurality of fiber materials; a second preparation step of preparing a medium raw material including a plurality of fiber materials and a binding raw material containing a glue, wherein the binding raw material is capable of switching between a solute state and a binding state; a filling step, wherein when the binding raw material is in the solute state, stirring and mixing the medium raw material and the binding raw material, and filling a mold with the mixture; a shaping step of allowing the mixture to stand for a period of time so as to make the binding raw material switch to the binding state, whereby the binding raw material and the medium raw material are banded and shaped into a cup-shaped post-medium; and a placement step of placing the pre-medium cultivated with the plant into cup-shaped post-medium.

In one embodiment, a manufacturing method, applicable to manufacture the plant growth medium, comprises a first preparation step of preparing a pre-medium cultivated a plant, wherein the pre-medium is of a porous structure formed by a plurality of fiber materials; a second preparation step of preparing a medium raw material including a plurality of fiber materials and a binding raw material containing a glue, wherein the binding raw material is capable of switching between a solute state and a binding state; a filling step, wherein when the binding raw material is in the solute state, stirring and mixing the medium raw material and the binding raw material, and filling a mold with the mixture; a combination step, wherein when the binding raw material remains in the solute state, placing the pre-medium cultivated with the plant in the mold, such that the mixture of the medium raw material and the binding raw material covers the pre-medium; and a shaping step of allowing the mixture to stand for a period of time so as to make the binding raw material switch to the binding state, whereby the binding raw material and the medium raw material are banded and shaped into the post-medium fixated on a periphery of the pre-medium.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a schematic perspective view of a pre-medium and a post-medium before combination according to a first embodiment of the present disclosure.

FIG. 2 is a schematic perspective view of the pre-medium and the post-medium after combination according to the first embodiment.

FIG. 3 is a flowchart of a manufacturing method of a plant growth medium according to the first embodiment.

FIG. 4 is a schematic perspective view showing a medium injection module and a binding injection module are used to inject a medium raw material and a binding raw material into a mold according to the first embodiment.

FIG. 5 is a schematic perspective view of using an upper mold and a lower mold to manufacture the post-medium according to the first embodiment.

FIG. 6 is a schematic perspective view of a connection layer disposed between the pre-medium and the post-medium according to the first embodiment.

FIG. 7 is a schematic perspective view of a medium container accommodating the post-medium according to the first embodiment.

FIG. 8 is a three-dimensional schematic diagram of a plurality of side plates and a plurality of base plates that can form a post-medium according to a second embodiment of the present disclosure.

FIG. 9 is a schematic perspective view of an enclosed space formed in the plant growth medium according to a third embodiment of the present disclosure.

FIG. 10 is a schematic perspective view of using an upper mold and a lower mold to combine a pre-medium with a post-medium according to a fourth embodiment of the present disclosure.

FIG. 11 is a flowchart of a manufacturing method of a plant growth medium according to the fourth embodiment.

### DETAILED DESCRIPTION

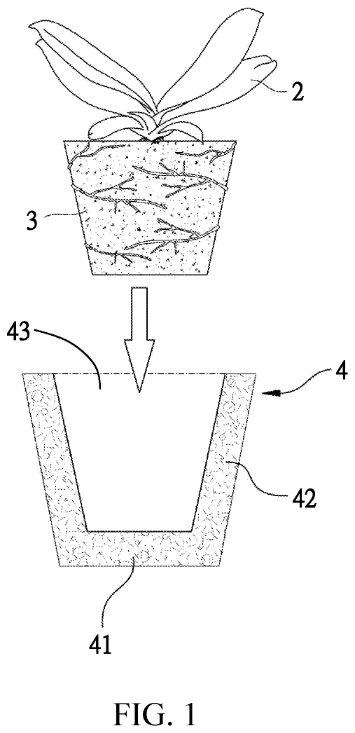

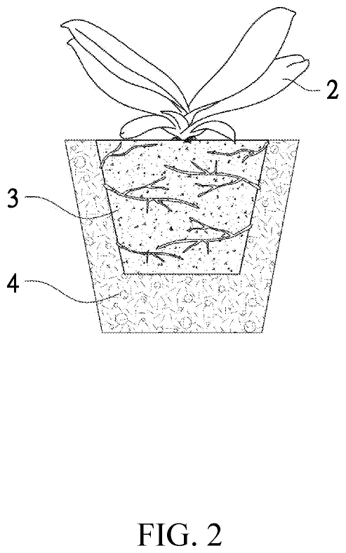

As shown in FIGS. 1 and 2, a plant growth medium is provided according to a first embodiment of the present disclosure, applicable to grow a plant 2, including a pre-medium 3 and a post-medium 4.

It should be noted that the pre-medium 3 is cultivated with the plant 2 which is an orchid, the pre-medium 3 being columnar. The plant 2 grows in the pre-medium 3 for a period of time. As its root grows, the growth space provided by the pre-medium 3 becomes insufficient. Therefore, the post-medium 4 is configured to provide extra space and environment for the plant 2 to continue to grow. For example, the plant 2 may be other plants and the pre-medium 3 may be in other shapes, which should not be limited thereto.

The post-medium 4 includes a bottom wall 41, a surrounding wall 42 extending upward from an outer edge of the bottom wall 41, an accommodating space 43 defined jointly by the bottom wall 41 and the surrounding wall 42. The accommodating space 43 tightly fits the pre-medium 3, allowing the pre-medium 3 to be accommodated in the accommodating space 43. For example, the post-medium 4 is in columnar shape, which should not be limited thereto.

The pre-medium 3 and the post-medium 4 are made of a medium raw material 62 and a binding raw material 64. For example, the medium raw material 62 may be used alone as the manufacturing material, which should not be limited thereto. The medium raw material 62 is formed by a plurality of fibers or may be added with granules or powder. The binding raw material 64 can switch from the solute state to the binding raw material. The binding raw material 64, as a polymeric adhesive, is configured to bind the medium raw material 62. Because the adhesive molecules need to generate more interaction forces, the adhesive is typically in a liquid solute state. The hollows on the surface of the adhered material are filled with the flowing material due to its characteristics to increase the contact area between the adhesive and the adhered material. When the adhesive produces a shaping effect and the binding raw material enters the binding state, the molecules of the adhesive can form a porous elastic structure. This produces physical latching properties that can be used to resist external forces so as to bind the adhered objects. Besides, the adhesion effect of the adhesive can also be enhanced through the chemical force. For example, some adhesives produce heat and foam reaction after water adding and form elastic porous structures after cooling. Other adhesives when heated are soluble to promote chemical reactions and when cooled switch to the binding state. Since there are many types of adhesives, details are not described herein. In some examples, the medium raw material 62 may be selected from the group consisting of natural fibers such as coir or sphagnum moss or artificial fibers (PA+PET). The binding raw material 64 is glue. For example, the medium raw material 62 may be selected from one or a combination of the group consisting of baked expanded clay pellets, coal cinder, cork, glass wool, organic fibers, inorganic fibers, peat, perlite, phenol formaldehyde, plastic particles, polyethylene, polymer stabilized starch, polystyrene, polyurethane, rock wool, sphagnum moss, urea formaldehyde, stockosorb super absorbent polymer, vermiculite, volcanic rock, zeolite, polyvinyl alcohol (PVA), artificial fiber (PA+PET), or cellulose, coir. The binding raw material 64 may be selected from one or a combination of the group consisting of formed glue, polyurethane, polyvinyl alcohol (PVA), polyethylene, polyphenylene, starch, cresol, methylphenol, artificial fiber (PA, PET), absorbent, or glue, should not be limited to examples.

It should be noted that since the medium raw material 62 is formed by a plurality of fibers, the binding raw material 64 binds the fibers to shape them, perforations are formed between the fibers, providing functions such as air permeability, moisture retention, and thermal insulation. Besides, the fibers of the medium raw material 62 are inherently elastic, and the binding raw material 64 may further be made of materials that are elastic in the binding state. Thus, when the binding raw material 64 binds and shapes the medium raw material 62 into the pre-medium 3 or the post-medium 4, the entire structure is also elastic. Therefore, the pre-medium 3 or the post-medium 4 is of an elastic porous structure.

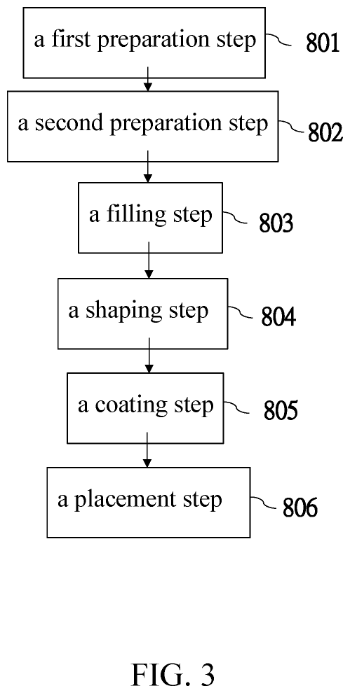

Turning to FIG. 3, the manufacturing method of the plant growth medium includes a first preparation step 801, a second preparation step 802, a filling step 803, a shaping step 804, a coating step 805, and a placement step 806.

In the first preparation step 801, the pre-medium 3 cultivated with the plant 2 is prepared, and the pre-medium 3 is of a porous structure formed by a plurality of fiber materials. In some examples, the pre-medium 3 and the post-medium 4 are made of the same material and are of the same internal structure, which should not be limited thereto.

In the second preparation step 802, a medium raw material 62 including the plurality of fiber materials and a binding raw material 64 containing a glue are prepared, where the binding raw material 64 is capable of switching between a solute state and a binding state.

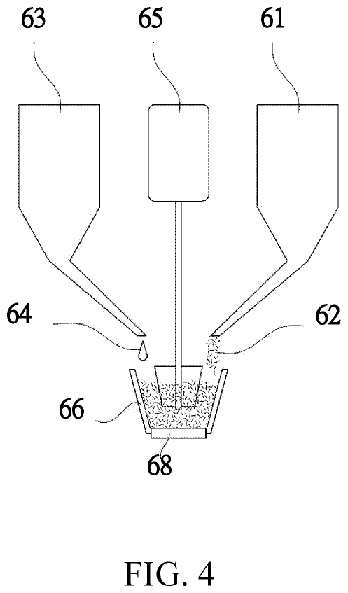

As shown in FIG. 4, in the filling step 803, when the binding raw material 64 is in the solute state, the medium raw material 62 and the binding raw material 64 are stirred and mixed, and a mold is filled with the mixture. In some examples, a medium injection module 61 is used to inject the medium raw material 62 into a lower mold 66, a binding injection module 63 is used to inject the binding raw material 64 into the lower mold 66, and then a raw material stirring module 65 is used to stir and mix the medium raw material 62 and the binding raw material 64 in the lower mold 66.

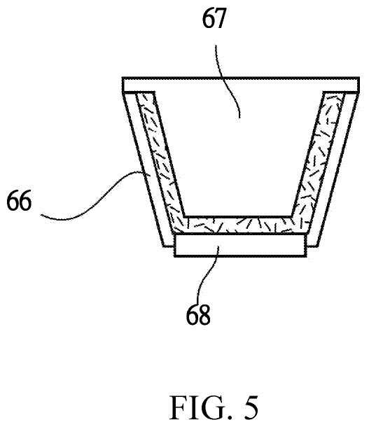

Turning to FIG. 5, in the shaping step 804, an upper mold 67 is used to apply pressure to the medium raw material 62 and the binding raw material 64 in the lower mold 66 and shape the structure. After the mixture is left standing for a period of time, the binding raw material 64 switches to the binding state. The binding raw material 64 and the medium raw material 62 are banded and shaped into the post-medium 4. In some examples, the post-medium 4 is cup-shaped, which is however not limited thereto. The bottom of the lower mold 66 is further provided with a lift plate 68. When the post-medium 4 is stable, the lift plate 68 can be raised with respect to the lower mold 66 to push the post-medium 4 out of the lower mold 66.

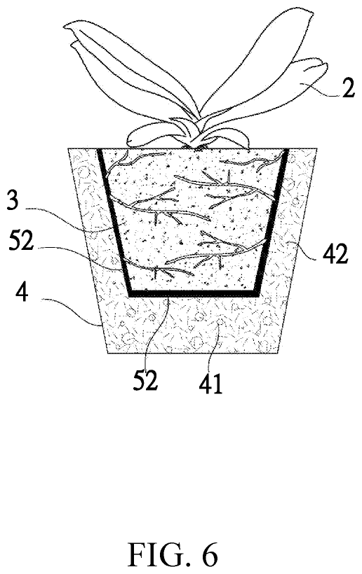

As shown in FIG. 6, in the coating step 805, a side surface and a bottom surface of the pre-medium 3 or a surface of the post-medium 4 located in the accommodating space 43 is coated with the binding raw material, and when the binding raw material is still in the solute state, perform the placement step 806.

In the placement step 806, the pre-medium 3 cultivated with the plant 2 is placed in the cup-shaped post-medium 4. The post-medium 4 can provide more growth space for the root of the plant 2. The binding raw material for coating in the coating step 805 forms a connection layer 52 between the pre-medium 3 and the post-medium 4. The connection layer 52 can combine the surrounding wall 42 with the external periphery of the pre-medium 3, and the connection layer 52 extends to a surface of the bottom wall of the post-medium 3, thus connecting the bottom of the pre-medium 3 to the bottom wall 41. The connection layer 52 is used to tightly bind the pre-medium 3 and the post-medium 4, such that the pre-medium 3 does not fall off from the post-medium 4. For example, in the manufacturing method, the coating step 805 may be skipped, making the plant growth medium have no the connection layer 52, which should not be limited thereto.

In some examples, the manufacturing method of the plant growth medium can also be carried out through an automated process. For example, a conveyor belt module (not shown in the figure) conveys a plurality of lower molds 66 and a plurality of lift plates 68, allowing these lower molds 66 and lift plates 68 to sequentially pass through the medium injection module 61, the binding injection module 63, the raw material stirring module 65, a molding pressurizing module (not shown in the figure), and a finished product extracting module (not shown in the figure). The medium injection module 61 injects the medium raw material 62 into the lower molds 66, and the binding injection module 63 injects the binding raw material 64 into the lower molds 66. The raw material stirring module 65 stirs and mixes the medium raw material 62 and the binding raw material 64 in the lower mold 66. The molding pressurizing module drives upper molds 67 to pressurize the medium raw material 62 and the binding raw material 64 in the lower molds 66 into the post-medium 4. The finished product extracting module drives the lift plates 68 to push out the post-media 4 in lower molds 66, to obtain the finished post-medium 4.

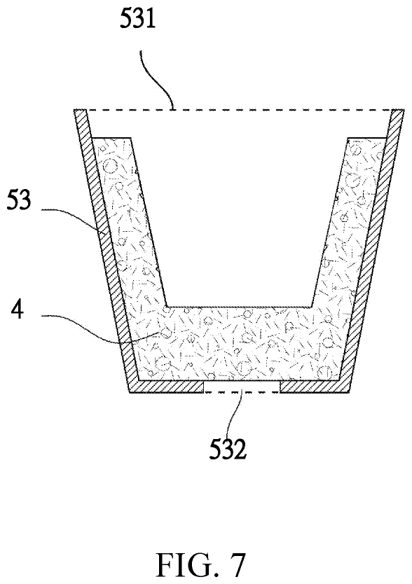

As shown in FIG. 7, the plant growth medium further includes a medium container 53. The medium container 53 defines an accommodating tank 531. The post-medium 4 is disposed in the accommodating tank 531. In some examples, the medium container 53 is a transparent plastic film of 0.01 mm to 0.5 mm, and the bottom is provided with ventilation holes 532, but the structure is not limited thereto. When the post-medium 4 is made, it can be placed in the medium container 53 and sold together as a product. The medium container 53 not only prevents the fibers of the medium raw material 62 from falling off, but also takes up less space and cost less, and therefore can replace heavy pots to accommodate the plant growth medium.

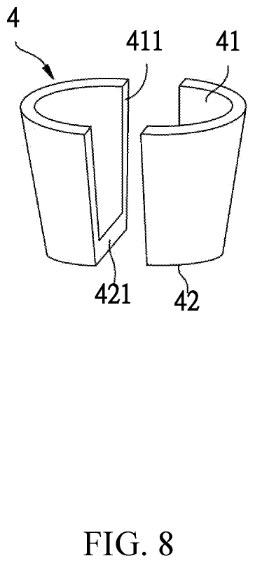

Turning to FIG. 8, according to a second embodiment of the present disclosure, a plant growth medium is provided. The second embodiment differs from the first embodiment in that the bottom wall 41 is formed by base plates 411, the surrounding wall 42 is formed by curved side plates 421, each side plate 421 being upright and one of the base plates 411 are connected and formed integrally as an assembly (the structure formed by the base plate 411 and the side plate 421 as shown in FIG. 8). The two assemblies are aligned together to form the post-medium 4.

In the second embodiment, in the filling step 803 of the manufacturing method of the plant growth medium, the medium raw material 62 and the binding raw material 64 are stirred and mixed, and molds (not shown in the figure) are filled with the mixture. Each mold is used to manufacture a structure formed by one base plate 411 and one side plate 421. In addition, in the shaping step 804, an assembly can be taken out from each mold, and the post-medium 4 is formed by assemblies taken out from the molds. The technology of extrusion molding using a mold is well known and not described in detail herein.

In the second embodiment, two molds are provided, and therefore two assemblies are obtained. The two assemblies are equally divided sections of the post-medium 4. For example, multiple molds can be created by dividing them equally (for example, into three or four equal sections), and then assemblies in the molds are combined to form a complete post-medium 4. The assemblies made in this way can be layered, so when packed and shipped, boxes of the layered assemblies can be increased. When used on the backend, the assemblies can be combined into the post-medium 4, and the pre-medium 2 is placed in the post-medium 4 to expand the growth medium. The assemblies can be placed in the medium container 53, so as to form the post-medium 4 in the medium container 53.

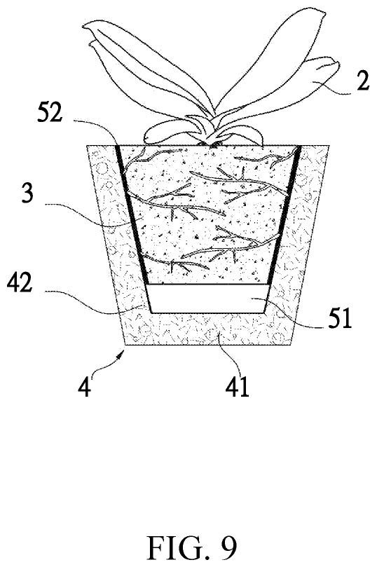

As shown in FIG. 9, according to a third embodiment of the present disclosure, a plant growth medium is provided. The third embodiment differs from the first embodiment in that a side edge of the pre-medium 3 is connected to the surrounding wall 42, the bottom edge of the pre-medium 3 and the bottom wall 41 are spaced apart, and the pre-medium 3, the surrounding wall 42, and the bottom wall 41 fit each other to surround the accommodating space 43 and define an enclosed space 51. The enclosed space 51 can provide more space for the root of the plant 2 to grow. The inner side of the surrounding wall 42 is wide at the top and narrow at the bottom, the top of the accommodating space 43 being greater than the periphery of the pre-medium 3, and the bottom of the accommodating space 43 being narrower than the periphery of the pre-medium 3. Therefore, when the pre-medium 3 is placed in the accommodating space 43, the pre-medium 3 is blocked by the surrounding wall 42, thus forming the closed space 51.

Besides, the plant growth medium further includes a connection layer 52 between the pre-medium 3 and the post-medium 4. The connection layer 52 is formed by the binding raw material to bind the surrounding wall 42 and the external periphery of the pre-medium 3. For example, before the pre-medium 3 is placed in the accommodating space 43, the inner surface of the surrounding wall 42 can be coated with the binding raw material or a side surface of the pre-medium 3 is coated with the binding raw material. After the pre-medium 3 is placed in the accommodating space 43, the binding raw material can switch from the solute state to the binding state, thus forming the connection layer 52, and tightly binding the pre-medium 3 and the post-medium 4. This can prevent the pre-medium 3 from falling off from the post-medium 4. For example, the connection layer 52 in the plant growth medium can be generated without using the binding raw material 64, which should not be limited thereto.

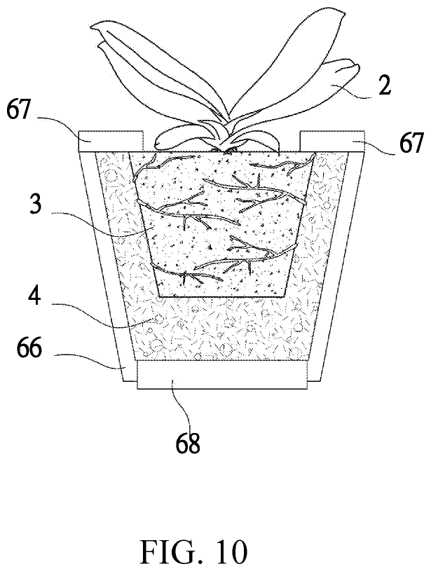

Turning to FIG. 10, according to a fourth embodiment of the present disclosure, a plant growth medium is provided. The fourth embodiment differs from the first embodiment in that it takes 20 s to 100 s for the binding raw material 64 to switch from the solute state to the binding state, but in some examples, the time required by the binding raw material 64 to switch from the solute state to the binding state should be determined by the type characteristics of binding raw material 64 or the overall structural volume of the post-medium 4, which is not limited thereto.

When the binding raw material 64 is in the solute state, the medium raw material 62 is mixed with the binding raw material 64, and the pre-medium 3 is combined with the mixture of the medium raw material 62 and the binding raw material 64. When the binding raw material 64 switches to the binding state, the medium raw material 62 and the bottom edge and side edge of the binding raw material 64 in the pre-medium 3 directly form the post-medium 4, and the binding raw material 64 can also tightly bind the bottom wall 41 of the post-medium 4, the surrounding wall 42, and the surface of the pre-medium 3.

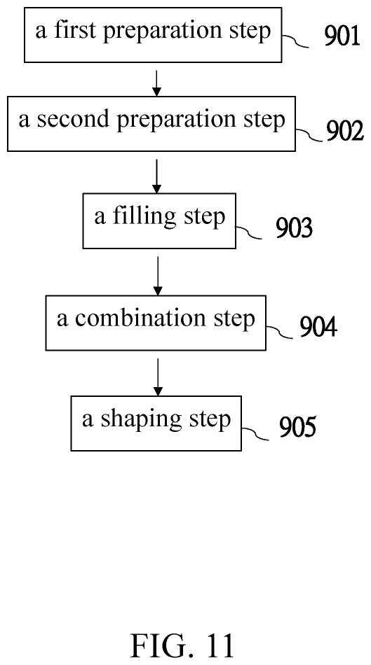

As shown in FIG. 11, the manufacturing method of the plant growth medium according to the fourth embodiment of the present disclosure includes a first preparation step 901, a second preparation step 902, a filling step 903, a combination step 904, and a shaping step 905.

In the first preparation step 901: The pre-medium 3 cultivated with the plant 2 is prepared, and the pre-medium 3 is of a porous structure formed by a plurality of fiber materials.

In the second preparation step 902, a medium raw material 62 including the plurality of fiber materials and a binding raw material 64 including a glue are prepared, where the binding raw material is capable of switching between a solute state and a binding state.

With continued reference to FIG. 4, in the filling step 903, when the binding raw material 64 is in the solute state, the medium raw material 62 and the binding raw material 64 are stirred and mixed, and a mold is mixed with the mixture.

With continued reference to FIG. 10, in the combination step 904, when the binding raw material 64 remains in the solute state, the pre-medium 3 cultivated with the plant is combined in the mold, and the mixture of the medium raw material 62 and the binding raw material 64 covers the side edge and the bottom edge of the pre-medium 3. The lower mold 66 is used to shape the side part of the post-medium 4, the upper mold 67 is used to shape the top of the post-medium 4, and the pre-medium 3 is used to shape the accommodating space 43 of the post-medium 4.

In the shaping step 905, when the mixture is left standing for a period of time and the binding raw material 64 switches to the binding state, the binding raw material 64 and the medium raw material 62 are banded and shaped into the post-medium 4 fixated on a periphery of the pre-medium 3.

In addition, it should be noted that as size of the pot is fixed typically, after the plant 2 is planted in the pre-medium 3 and grows in the pot for a period of time, the root of the plant 2 gradually grows larger and squeeze the pre-medium 3 in the pot, thus gradually moving the pre-medium 3 out of the pot. Therefore, the growth space available for the root of the plant 2 in the pre-medium 3 is already limited and the growth space for the root of the plant 2 needs to be expanded. In this case, the plant 2 can be taken out with the pre-medium 3 from the pot, and the pre-medium 3 is fixed to the upper mold 67. The plant 2 is inserted in the perforation of the upper mold 67, and then the post-medium 4 is manufactured. Preferably, the medium injection module 61 and the binding injection module 63 are first used to inject the medium raw material 62 and the binding raw material 64 into the lower mold 66, and then the raw material stirring module 65 is used to stir and mix the medium raw material 62 and the binding raw material 64 in the lower mold 66. Next, the molding pressurizing module is used to control the upper mold 67 to pressurize the pre-medium 3 into the lower mold 66, directly pressurizing the outer edge of the pre-medium 3 and shaping it into the post-medium 4. At last, the finished product extracting module is used to control the lift plate 68 to push out the post-medium 4 from the lower mold 66, finally obtaining the plant growth medium of the post-medium 4 able to accommodate the pre-medium 3. For example, other automatic processing methods can be used and should not be limited thereto.

As can be seen from the above description, the plant growth medium and the manufacturing method of the present disclosure may have the following features.

First, achieving mass production with stable quality:

The plant growth medium can be produced by automatic processing. This can not only save the costs of manual processing, but also avoid manual processing errors, and the automatic processing line can also stabilize the quality of production, thus implementing mass processing.

Second, preventing the medium from falling off:

The connection layer 52 binds the pre-medium 3 and the post-medium 4. In addition, when the binding raw material 64 remains in the solute state, the post-medium 4 can be directly manufactured outside the pre-medium 3 and tightly banded, preventing the medium from falling off.

Third, providing a healthy growth environment:

The enclosed space 51 being disposed in the plant growth medium can provide more growth space for the root of the plant 2, and the pre-medium 3 and the post-medium 4 are of elastic porous structures, characterized in air permeability, moisture retention, thermal insulation, and the like, thus providing a healthy growth environment for the root of the plant 2.

In sum, the pre-medium 3 and the post-medium 4 being of elastic porous structures are characterized in air permeability, moisture retention, thermal insulation, and the like. This can provide a healthy growth environment for the root of the plant 2. In addition, the binding raw material 64 can tightly band the pre-medium 3 and the post-medium 4, preventing the medium from falling off. Furthermore, the enclosed space 51 can provide more growth space for the root of the plant 2, thus achieving the objective of the present disclosure.

Although the concept herein has been described with reference to particular examples, it is to be understood that these examples are merely illustrative of the principles and applications of the present concept. It is therefore to be understood that numerous modifications may be made to the illustrative examples and that other arrangements may be devised without departing from the spirit and scope of the present concept as defined by the appended claims.

What is claimed is:

1. A plant growth medium, applicable to grow a plant, comprising:
a pre-medium cultivated with the plant; and
a post-medium including a bottom wall, a surrounding wall extending upward from an outer edge of the bottom wall, and an accommodating space defined jointly by the bottom wall and the surrounding wall, wherein the pre-medium is accommodated in the accommodating space to provide a growth environment for the plant.

2. The plant growth medium according to claim 1, wherein the bottom wall is formed by a plurality of base plates and the surrounding wall is formed by a plurality of side plates, wherein each side plate is connected upright to one of the base plates to form an assembly, and the plurality of assemblies are combined to form the post-medium.

3. The plant growth medium according to claim 1, wherein a side edge of the pre-medium is connected to the surrounding wall, a bottom edge of the pre-medium and the bottom wall are spaced apart, and the pre-medium, surrounding wall, and bottom wall cooperate to define an enclosed space in the accommodating space.

4. The plant growth medium according to claim 1, wherein the pre-medium and the post-medium are made of a medium raw material and a binding raw material, wherein the medium raw material is formed by a plurality of fibers and the binding raw material is configured to bind the medium raw material.

5. The plant growth medium according to claim 4, further comprising a connection layer between the pre-medium and the post-medium, wherein the connection layer is the binding raw material to combine the surrounding wall with an external periphery of the pre-medium.

6. The plant growth medium according to claim 5, further comprising a medium container, wherein the medium container defines an accommodating tank, and the post-medium is disposed in the accommodating tank.

7. A manufacturing method, applicable to manufacture the plant growth medium according to claim 1, comprising:
a first preparation step of preparing a pre-medium cultivated with a plant, wherein the pre-medium is of a porous structure formed by a plurality of fiber materials;
a second preparation step of preparing a medium raw material including a plurality of fiber materials and a binding raw material containing a glue, wherein the binding raw material is capable of switching between a solute state and a binding state;
a filling step, wherein when the binding raw material is in the solute state, stirring and mixing the medium raw material and the binding raw material, and filling a mold with the mixture;
a shaping step of allowing the mixture to stand for a period of time so as to make the binding raw material switch to the binding state, whereby the binding raw material and the medium raw material are banded and shaped into a cup-shaped post-medium; and
a placement step of placing the pre-medium cultivated with the plant into cup-shaped post-medium.

8. The manufacturing method according to claim 7, wherein in the filling step, the medium raw material and the binding raw material are stirred and mixed, and a plurality of molds are filled with the mixture, and in the shaping step, an assembly is capable of being taken out from each mold, and the post-medium is formed by a plurality of assemblies taken out from the plurality of molds.

9. The manufacturing method according to claim 7, further comprising a coating step between the shaping step and the placement step, wherein in the coating step, a surface of the pre-medium or the post-medium is coated with the binding raw material, and in the placement step, the binding raw material between the pre-medium and the post-medium forms a connection layer.

10. The manufacturing method according to claim 8, further comprising a coating step between the shaping step and the placement step, wherein in the coating step, a surface of the pre-medium or the post-medium is coated with the binding raw material, and in the placement step, the binding raw material between the pre-medium and the post-medium forms a connection layer

11. A manufacturing method, applicable to manufacture the plant growth medium according to claim 1, comprising:
a first preparation step of preparing a pre-medium cultivated a plant, wherein the pre-medium is of a porous structure formed by a plurality of fiber materials;
a second preparation step of preparing a medium raw material including a plurality of fiber materials and a binding raw material containing a glue, wherein the binding raw material is capable of switching between a solute state and a binding state;
a filling step, wherein when the binding raw material is in the solute state, stirring and mixing the medium raw material and the binding raw material, and filling a mold with the mixture;
a combination step, wherein when the binding raw material remains in the solute state, placing the pre-medium cultivated with the plant in the mold, such that the mixture of the medium raw material and the binding raw material covers the pre-medium; and
a shaping step of allowing the mixture to stand for a period of time so as to make the binding raw material switch to the binding state, whereby the binding raw material and the medium raw material are banded and shaped into the post-medium fixated on a periphery of the pre-medium.
